(19) United States
(12) Patent Application Publication
(10) Pub. No.: US 2023/0065332 A1
(43) Pub. Date: Mar. 2, 2023

(54) HEATING CORE, ELECTRONIC CIGARETTE, AND PREPARATION METHODS THEREOF

(71) Applicant: Shenzhen Eigate Technology Co., Ltd., Shenzhen (CN)

(72) Inventor: Tuanfang LIU, Shenzhen (CN)

(21) Appl. No.: 17/692,099

(22) Filed: Mar. 10, 2022

(30) Foreign Application Priority Data
Aug. 31, 2021 (CN) 202111015823.8
Aug. 31, 2021 (CN) 202122104062.5
Sep. 22, 2021 (CN) 202111109634.7
Sep. 22, 2021 (CN) 202122292024.7

(51) Int. Cl. A24F 40/44; A24F 40/46; A24F 40/10; A24F 40/485; A24F 40/70; A24F 40/42; B28B 1/24; B28B 23/00

(52) U.S. Cl. CPC A24F 40/44; A24F 40/46; A24F 40/10; A24F 40/485; A24F 40/70; A24F 40/42; B28B 1/24; B28B 23/0056; H05B 2203/017; H05B 2214/04; H05B 2203/021

(57) ABSTRACT

A heating core includes a conductor and an e-liquid absorber. The conductor includes a cavity and the e-liquid absorber is disposed in the cavity.

### CROSS-REFERENCE TO RELATED APPLICATIONS

Pursuant to 35 U.S.C. § 119 and the Paris Convention Treaty, this application claims foreign priority to Chinese Patent Application No. 202111015823.8 filed Aug. 31, 2021, to Chinese Patent Application No. 202122104062.5 filed Aug. 31, 2021, to Chinese Patent Application No. 202111109634.7 filed Sep. 22, 2021, and to Chinese Patent Application No. 202122292024.7 filed Sep. 22, 2021. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a heating core, an electronic cigarette, and preparation methods thereof.

A conventional electronic cigarette includes e-liquid absorbent cotton or a ceramic body for absorbing the e-liquid to be atomized. The absorption effect of the ceramic body on thick e-liquid is not good. The cotton is loose and the e-liquid may leak therefrom. In addition, when the atomized e-liquid cools to yield the condensate, the condensate tends to block the air channel of the electronic cigarette. Furthermore, the e-liquid absorbent cotton may burn due to excessive heat. The e-liquid absorbent cotton is usually manually disposed within the conventional electronic cigarette. The manual operation cannot ensure the uniformity of the cotton, thus affecting the taste of the electronic cigarette.

### SUMMARY

The first objective of the disclosure is to provide a heating core; the heating core comprises a conductor and an e-liquid absorber with a fixed structure; the conductor comprises a cavity and the e-liquid absorber is disposed in the cavity.

The second objective of the disclosure is to provide an electronic cigarette comprising the heating core.

The third objective of the disclosure is to provide a preparation method for the heating core, and the method comprises: fixing the conductor comprising the cavity in a mold; injecting a solidifiable material into the mold, and guiding the solidifiable material to the cavity; and solidifying the solidifiable material in the cavity to form the e-liquid absorber.

The fourth objective of the disclosure is to provide a preparation method for the electronic cigarette, the method comprises: preparing the heating core; and inserting the heating core into an e-liquid tank to form an electronic cigarette.

### BRIEF DESCRIPTION OF THE DRAWINGS

FIG. 1 is a perspective view of a heating core according to one embodiment of the disclosure;

FIG. 2 is a cross-sectional view of a heating core in FIG. 1;

FIG. 3 is a perspective view of a heating core according to one embodiment of the disclosure;

FIG. 4 is a cross-sectional view of a heating core in FIG. 3;

FIG. 5 is a perspective view of a heating core according to one embodiment of the disclosure;

FIG. 6 is a cross-sectional view of a heating core in FIG. 5;

FIG. 7 is a perspective view of an electronic cigarette according to one embodiment of the disclosure;

FIG. 8 is a flow chart depicting a method for preparing a heating core according to one embodiment of the disclosure;

FIG. 9 is a flow chart depicting a method for fixing a conductor in a mold according to one embodiment of the disclosure;

FIG. 10 is a flow chart depicting a method for preparing an e-liquid absorber by solidifying solidifiable material according to one embodiment of the disclosure;

FIG. 11 is a flow chart depicting a method for preparing a heating core according to one embodiment of the disclosure;

FIG. 12 is another flow chart depicting a method for preparing a heating core according to one embodiment of the disclosure; and

FIG. 13 is a flow chart depicting a method for preparing an electronic cigarette according to one embodiment of the disclosure;

In the drawings, the following reference numbers are used: 1. Conductor; 2. E-liquid absorber; 3. Heating element; 11. Cavity; 12. Channel; 13. E-liquid inlet; 21. Through hole; 31. Conductive pin; 41. Mouthpiece; 100. Electronic cigarette; 101. First hollow tube; 102. Second hollow tube; 900. Second preparation method; 1000. Third preparation method; and 1100. Fourth preparation method.

### DETAILED DESCRIPTION

To further illustrate the disclosure, embodiments detailing a heating core, an electronic cigarette, and preparation methods thereof are described below. It should be noted that the following embodiments are intended to describe and not to limit the disclosure.

A heating core comprises a conductor and an e-liquid absorber with a fixed structure. The conductor comprises a cavity and the e-liquid absorber is disposed in the cavity.

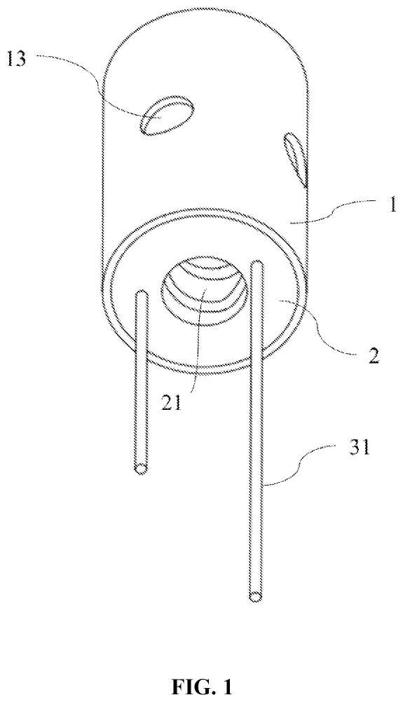

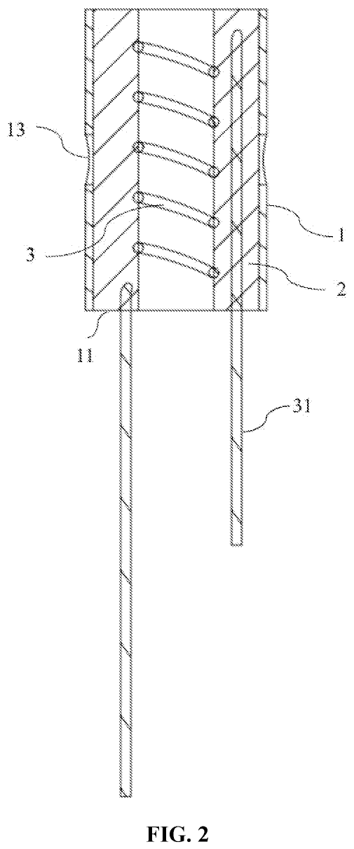

As shown in FIGS. 1-2, a heating core comprises the conductor 1 and an e-liquid absorber 2. The conductor 1 comprises a cavity 11 disposed in the e-liquid absorber 2. The conductor 1 is wrapped around the e-liquid absorber 2 to increase the heating area so that the heat can be transferred rapidly between the conductor 1 and the e-liquid absorber 2. The e-liquid absorber 2 is formed using an injection molding process which offers advantages such as automatic production and consistency in product quality, thus improving the taste of the e-cigarette. The e-liquid absorber 2 is used to seal the cavity 11 to prevent leakage of the e-liquid. The temperature of the conductor 1 reduces the viscosity of the e-liquid to improve the degree of atomization, thus providing a smooth flow of e-liquid into the cavity 11.

In certain examples, the e-liquid absorber 2 is obtained by injecting solidifiable material into a mold, and then hardening and sintering the solidifiable material. The e-liquid absorber 2 is formed using the injection molding process which offers advantages such as automatic production and consistency in product quality, thus improving the taste of the e-cigarette.

The e-liquid absorber 2 includes, but is not limited to, ceramic, mica, and e-liquid absorbing resin. The conductor 1 includes, but is not limited to, metal, graphene, and carbon nanomaterials.

The e-liquid absorber 2 comprises a first side wall and the conductor 1 comprises an inner wall. An outer surface of the first side wall is tightly attached to the inner wall to eliminate the gap therebetween and prevent the e-liquid from escaping through the gap.

In certain examples, the heating core further comprises a heating element 3 dispose in the e-liquid absorber 2. The heating element 3 is made of conductive metal. The conductive metal includes, but is not limited to, copper, aluminum, silver, nickel, tungsten, and gold. The conductive metal includes, but is not limited to, a heating wire, a heating sheet, and a heating cylinder. The heating wire and the heating sheet are formed in a spiral or wavy shape. The heating element 3 is wrapped around the e-liquid absorber 2 and comprises a conductive pin 31 extending through the e-liquid absorber 2 to the outside of the cavity 11. The conductive pin 31 is used to transport electricity from a power supply to the heating element 3. In certain examples, the heating element 3 is wrapped around the e-liquid absorber 2 spirally to provide uniform heating throughout the e-liquid. In certain examples, the e-liquid absorber 2 comprises at least one through hole 21 extending axially through a bottom surface and a top surface of the e-liquid absorber 2. As shown in FIG. 2, the e-liquid absorber 2 further comprises a second side wall surrounding the at least one through hole 21, and the heating element 3 is embedded into the second side wall; further, the heating element 3 is embedded into the second side wall spirally to provide uniform heating throughout the e-liquid.

Optionally, in certain examples, the conductor 1 is provided with the conductive pin 31 through which the electricity is directly transported from a power supply to the conductor 1 for heating.

Optionally, in certain examples, a coil is wrapped around the heating core to produce an electromagnetic field when an electric current is passing through the coil. The heating element 3 or the conductor 1 is heated from the electromagnetic field.

In certain examples, the conductor 1 further comprises at least one e-liquid inlet 13 communicating with the cavity 11 and opposite to the e-liquid absorber 2. The temperature of the conductor 1 reduces the viscosity of the e-liquid to improve the degree of atomization, thus providing a smooth flow of e-liquid into the cavity 11. Preferably, a plurality of e-liquid inlets 13 is disposed on the conductor 1 to ensure adequate e-liquid flows to the heating element 3, thus preventing the e-liquid absorber 2 from burning out. The solidifiable material is injected into the mold through the plurality of e-liquid inlets 13 to ensure the molding process runs smoothly and efficiently.

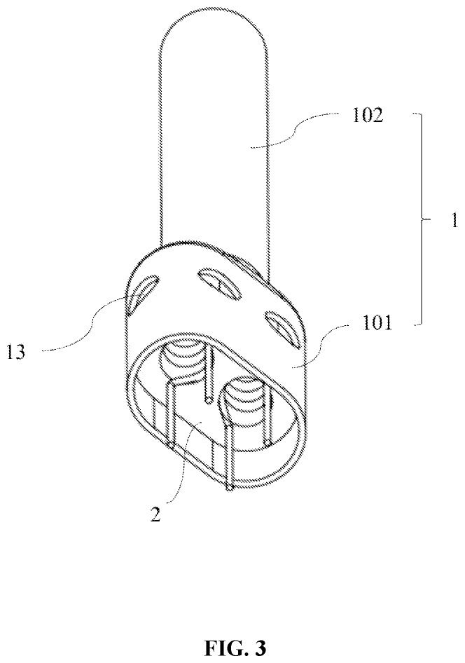

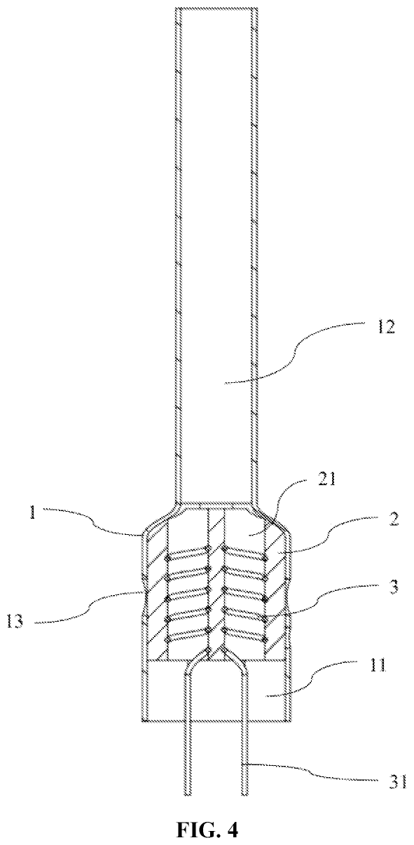

As shown in FIGS. 3-6, in certain examples, the conductor 1 further comprises a channel 12 communicating with the cavity 11. The temperature of the conductor 1 reduces chance of vapor being converted into condensate to ensure the channel 12 is unblocked. In certain examples, the channel 12 is formed integrally with the cavity 11. As shown in FIG. 4, the at least one through hole 21 extends at least into the channel 12, so that the heat produced by the heating element 3 can be conducted into the channel 12 to reduce chance of vapor being converted into condensate and ensure the channel 12 is unblocked.

As shown in FIGS. 1-2, in certain examples, the conductor 1 further comprises a first hollow tube 101. The cavity 11 is formed in the first hollow tube 101. A plurality of e-liquid inlets 13 is circumferentially disposed on the first hollow tube 101. The at least one through hole 21 extends axially through the bottom surface and the top surface of the e-liquid absorber 2. The heating element 3 is embedded into the second side wall of the at least one through hole 21 spirally.

As shown in FIGS. 3-4, in certain examples, the conductor 1 further comprises a second hollow tube 102. The first hollow tube 101 has an elliptical cross section and the second hollow tube 102 has a round cross section. One end of the first hollow tube 101 shrinks and extends axially to form the second hollow tube 102. The first hollow tube 101 communicates with the second hollow tube 102 using integral formation. The cavity 11 is formed in the first hollow tube 101 and the channel 12 is disposed in the second hollow tube 102. A plurality of e-liquid inlets 13 is circumferentially disposed on the first hollow tube 101. An electronic cigarette comprises an e-liquid chamber and a mouthpiece. The first hollow tube 101 and the second hollow tube 102 are disposed into the e-liquid chamber, and the second hollow tube 102 communicates with the mouthpiece. The first hollow tube 101 and the second hollow tube 102 have exceptional thermal conductivity, which means that the heat is conducted through the first hollow tube 101 and the second hollow tube 102 to reduce the viscosity of the e-liquid and improve the degree of atomization, thus providing a smooth flow of e-liquid into the cavity 11. The e-liquid absorber 2 comprises two through holes 21 axially extending through the bottom surface and the top surface of the e-liquid absorber 2. The heating core further comprises two heating elements 3 respectively embedded into the second side walls of the two through holes 21 spirally. The two through holes 21 allows a larger amount of smoke to pass through, thus enhancing user experience.

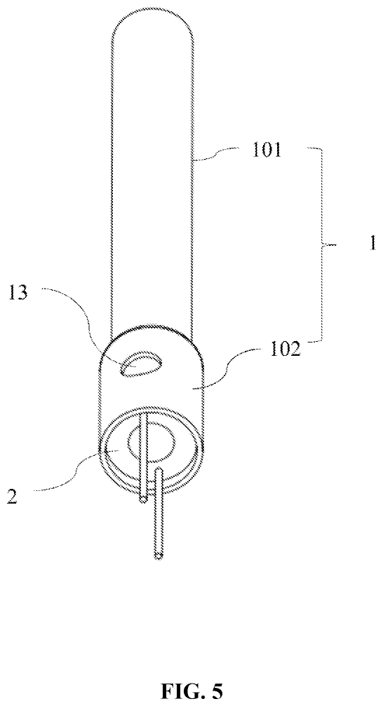

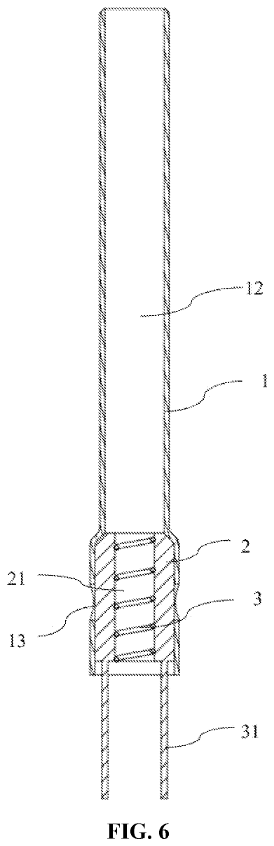

Another example of the heating core is illustrated in FIGS. 5-6. It is similar to the example described in connection with FIGS. 3-4, except for the following differences.

As shown in FIGS. 5-6, the conductor 1 comprises the first hollow tube 101 and the second hollow tube 102, both of which have a round cross section. One end of the first hollow tube 101 shrinks and extends axially to form the second hollow tube 102. The first hollow tube 101 communicates with the second hollow tube 102 using integral formation. The cavity 101 is formed in the first hollow tube 101 and the channel 12 is disposed in the second hollow tube 102. Two e-liquid inlets 13 are circumferentially disposed on the first hollow tube 101. An electronic cigarette comprises an e-liquid chamber and a mouthpiece. The first hollow tube 101 and the second hollow tube 102 are disposed into the e-liquid chamber, and the second hollow tube 102 communicates with the mouthpiece. The first hollow tube 101 and the second hollow tube 102 have exceptional thermal conductivity, which means that the heat is conducted through the first hollow tube 101 and the second hollow tube 102 to reduce the viscosity of the e-liquid and improve the degree of atomization, thus providing a smooth flow of e-liquid into the cavity 11.

As shown in FIG. 6, the e-liquid absorber 2 only comprises one through hole 21. The heating element 3 is embedded into the second side wall of the e-liquid absorber spirally. The only one through hole 21 extends into the channel 12 for heat conduction, and the heat is transferred to the channel, thus reducing the chance of the vapor converting into the condensate, and preventing the blockage of the channel.

As shown in FIG. 7, provided is an electronic cigarette 100 comprising the heating core (shown in FIGS. 3-4), an e-liquid tank, a mouthpiece 41, and a sealing member. The e-liquid tank comprises an e-liquid chamber 4 sealed by the sealing member (e.g. a sealing plug). The heating core is disposed into the e-liquid chamber 4. The mouthpiece 41 is disposed on one end of the e-liquid tank. The conductor 1 comprises the first hollow tube 101 and the second hollow tube 102 communicating with the first hollow tube 101. The cavity 11 is disposed in the first hollow tube 101. The channel 12 is disposed in the second hollow tube 102 to communicate with the cavity 11 and extend to the mouthpiece 41. At least one e-liquid inlet 13 is disposed on the first hollow tube 101. The first hollow tube 101 and the second hollow tube 102 extend into the e-liquid chamber 4, and the second hollow tube 102 communicates with the mouthpiece 41.

Understandably, the electronic cigarette 100 may comprise the heating core illustrated in FIGS. 1-2 or FIGS. 5-6.

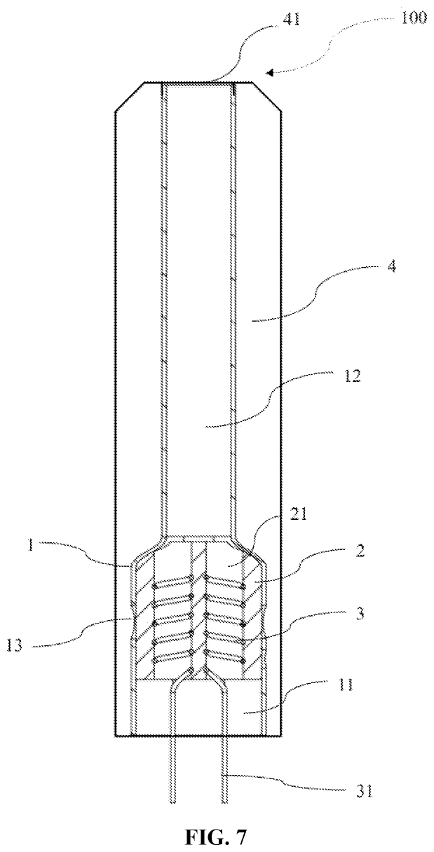

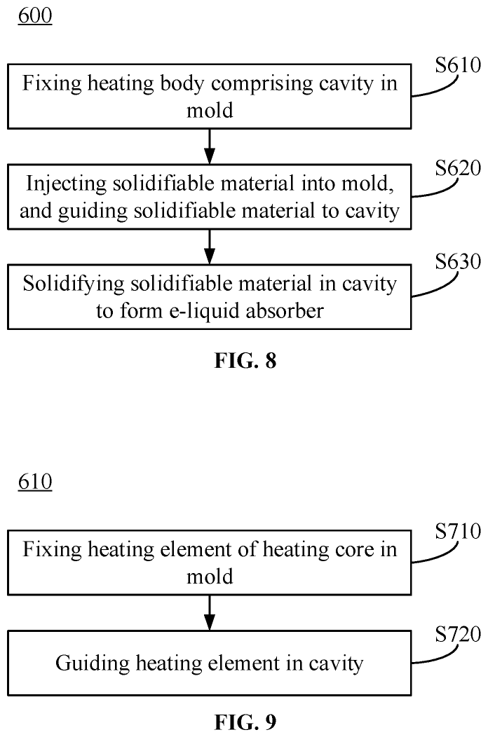

As shown in FIG. 8, a preparation method 600 for the heating core comprises:

S610. fixing the conductor 1 comprising the cavity 11 in a mold;

S620. injecting a solidifiable material into the mold, and guiding the solidifiable material to the cavity 11; the solidifiable material includes, but is not limited to, ceramic, mica, and e-liquid absorbing resin; and

S630. solidifying the solidifiable material in the cavity 1 to form the e-liquid absorber 2.

Through the preparation method, the e-liquid absorber 2 is directly disposed in the conductor thus greatly increasing the contact area therebetween, and the heat can be transferred rapidly between the e-liquid absorber 2 and the conductor.

As shown in FIG. 9, in certain examples, in S610, fixing the conductor 1 comprising the cavity 11 in a mold comprises:

S710. fixing the heating element 3 of the heating core in the mold; and

S720. guiding the heating element 3 in the cavity 11.

The heating element 3 is directly wrapped around the e-liquid absorber 2 by S710 and S720 so that the heating is uniform.

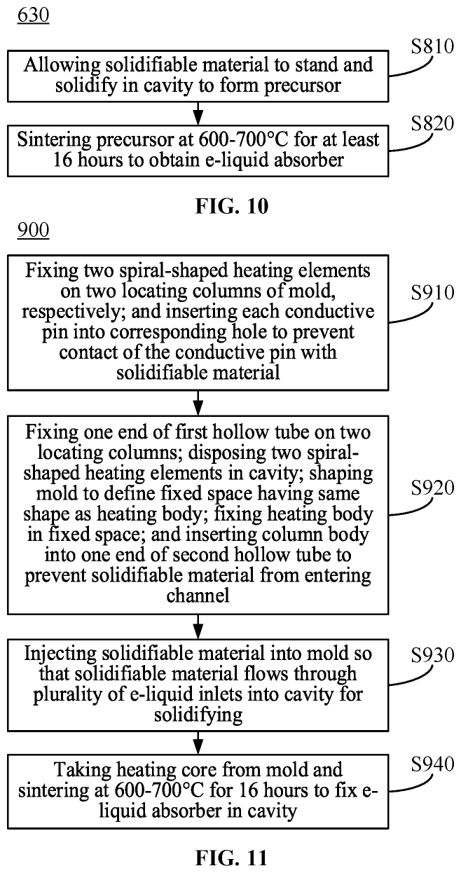

As shown in FIG. 10, in certain examples, in S630, solidifying the solidifiable material in the cavity 11 to form the e-liquid absorber 2 comprises:

S810. allowing the solidifiable material to stand and solidify in the cavity 11 to form a precursor; and

S820. sintering the precursor at 600-700° C. for at least 16 hours to obtain the e-liquid absorber 2.

In certain examples, the conductor further comprises at least one e-liquid inlet 13 communicating with the cavity 11 and opposite to the e-liquid absorber 2. The solidifiable material flows through the at least one e-liquid inlet 13 into the cavity 11. Preferably, a plurality of e-liquid inlets 13 is disposed on the conductor 1 to ensure adequate e-liquid flows to the heating element 3 and the molding process runs efficiently.

As shown in FIG. 11, a preparation method 900 for the heating core illustrated in FIGS. 3-4 comprises:

S910. fixing two spiral-shaped heating elements 3 on two locating columns of the mold, respectively; and inserting each conductive pin 31 into a corresponding hole in the mold to prevent the contact of the conductive pin with the solidifiable material;

S920. fixing one end of the first hollow tube 101 on the two locating columns; disposing two spiral-shaped heating elements 3 in the cavity 11; shaping the mold to define a fixed space having the same shape as the conductor 1; fixing the conductor 1 in the fixed space; and inserting a column body into one end of the second hollow tube 102 to prevent the solidifiable material from entering the channel 12;

S930. injecting the solidifiable material into the mold so that the solidifiable material flows through the plurality of e-liquid inlets 13 into the cavity 11 for solidifying; and

S940. taking the heating core from the mold and sintering at 600-700° C. for 16 hours to fix the e-liquid absorber 2 in the cavity 11.

Through the preparation method 900, two through holes 21 are disposed in the e-liquid absorber 2; the two spiral-shaped heating elements 3 are embedded into the second side walls of the two through holes 21, respectively; and each conductive pin 31 extends out of the first hollow tube 101.

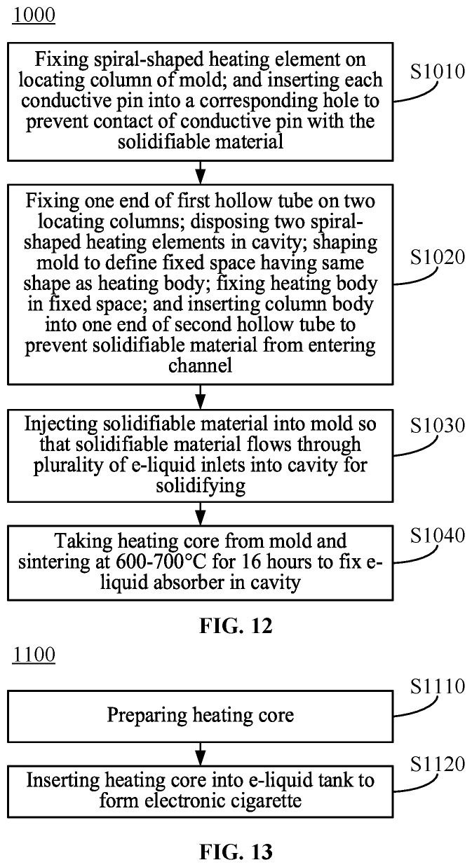

As shown in FIG. 12, a third preparation method 1000 for the heating core illustrated in FIGS. 5-6, the method comprises:

S1010. fixing a spiral-shaped heating element 3 on a locating column of the mold; and inserting each conductive pin 31 into a corresponding hole in the mold to prevent the contact of the conductive pin with the solidifiable material;

S1020. fixing one end of the first hollow tube 101 on the locating column; disposing one heating elements 3 in the cavity 11; shaping the mold to define a fixed space having the same shape as the conductor 1; fixedly disposing the conductor 1 in the fixed space; and inserting a column body into one end of the second hollow tube 102 to prevent the solidifiable material from entering the channel 12;

S1030. injecting the solidifiable material into the mold so that the solidifiable material flows through the plurality of e-liquid inlets 13 into the cavity 11 for solidifying; and

S1040. taking the heating core from the mold and sintering at 600-700° C. for 16 hours to fix the e-liquid absorber 2 in the cavity 11.

Depending on the third preparation method 1000 used, only one through hole 21 is disposed in the e-liquid absorber 2; the spiral-shaped heating element 3 is embedded into the second side wall of the only one through hole 21; and each conductive pin 31 extends out of the first hollow tube 101.

As shown in FIG. 13, a fourth preparation method 1100 for an electronic cigarette, the method comprises:

S1110. preparing the heating core; and

S1120. inserting the heating core into the e-liquid tank 4 to form an electronic cigarette.

It will be obvious to those skilled in the art that changes and modifications may be made, and therefore, the aim in the appended claims is to cover all such changes and modifications.

What is claimed is:

1. A heating core, comprising a conductor and an e-liquid absorber with a fixed structure; wherein the conductor comprises a cavity and the e-liquid absorber is disposed in the cavity.

2. The heating core of claim 1, wherein the conductor further comprises a channel communicating with the cavity.

3. The heating core of claim 1, wherein the e-liquid absorber is obtained by injecting a solidifiable material into a mold and hardening the solidifiable material, or injecting a solidifiable material into a mold, hardening and sintering the solidifiable material.

4. The heating core of claim 1, wherein the conductor comprises metal, graphene, or carbon nanomaterial; and the e-liquid absorber comprises ceramic, mica, or e-liquid absorbing resin.

5. The heating core of claim 1, wherein the e-liquid absorber comprises a first side wall and the conductor comprises an inner wall; and an outer surface of the first side wall is attached to the inner wall.

6. The heating core of claim 1, wherein the heating core further comprises a heating element dispose in the e-liquid absorber.

7. The heating core of claim 6, wherein the heating element comprises a conductive metal; the heating element comprises a conductive pin extending out of the e-liquid absorber; and the heating element is wrapped around the e-liquid absorber spirally.

8. The heating core of claim 1, wherein the conductor comprises a conductive pin.

9. The heating core of claim 2, wherein the conductor further comprises at least one e-liquid inlet communicating with the cavity and opposite to the e-liquid absorber.

10. The heating core of claim 1, wherein the e-liquid absorber comprises at least one through hole extending axially through a bottom surface and a top surface of the e-liquid absorber.

11. The heating core of claim 9, wherein the conductor further comprises a first hollow tube; the cavity is formed in the first hollow tube; and a plurality of e-liquid inlets is circumferentially disposed on the first hollow tube.

12. The heating core of claim 11, wherein the conductor further comprises a second hollow tube; one end of the first hollow tube shrinks and extends axially to form the second hollow tube; and the channel is disposed in the second hollow tube and communicates with the cavity.

13. An electronic cigarette, comprising the heating core of claim 1.

14. The electronic cigarette of claim 13, wherein the electronic cigarette further comprises an e-liquid tank and a mouthpiece; the e-liquid tank comprises an e-liquid chamber; the mouthpiece is disposed on one end of the e-liquid tank; the heating core is disposed in the e-liquid chamber; and at least part of an inner wall of the e-liquid tank corresponding to the e-liquid chamber operates as the conductor of the heating core.

15. A method for preparing a heating core, the method comprising:
fixing the conductor comprising the cavity in a mold;
injecting a solidifiable material into the mold, and guiding the solidifiable material to the cavity; and
solidifying the solidifiable material in the cavity to form the e-liquid absorber.

16. The method of claim 15, wherein fixing the conductor comprising the cavity in a mold comprises:
fixing a heating element in the mold; and
guiding the heating element into the cavity.

17. The method of claim 15, wherein solidifying the solidifiable material in the cavity to form the e-liquid absorber comprises:
allowing the solidifiable material to stand and solidify in the cavity to form a precursor; and
sintering the precursor at 600-700° C. for at least 16 hours to obtain the e-liquid absorber.

18. The method of claim 15, wherein the conductor further comprises at least one e-liquid inlet communicating with the cavity and opposite to the e-liquid absorber; and the solidifiable material flows through the at least one e-liquid inlet into the cavity.

19. A method for preparing an electronic cigarette, the method comprising:
preparing the heating core of claim 1; and
inserting the heating core into an e-liquid tank to form an electronic cigarette.
